(19) United States
(12) Patent Application Publication
(10) Pub. No.: US 2006/0273210 A1
(43) Pub. Date: Dec. 7, 2006

(54) Electrical retractor with pretensioner

(75) Inventors: Gunter K. Clute, Bloomfield Hills, MI (US); Robert A. Mical, Dearborn Heights, MI (US)

Correspondence Address: BRINKS HOFER GILSON & LIONE, P.O. BOX 10395, CHICAGO, IL, 60610, US

(73) Assignee: AUTOLIV ASP, INC.

(21) Appl. No.: 11/145,644

(22) Filed: Jun. 6, 2005

(51) Int. Cl. B60R 22/46

(52) U.S. Cl. 242/374; 242/379.1

(57) ABSTRACT

Disclosed is a seatbelt retractor having a frame, a spindle connected to a locking head, a gear wheel and a gear wheel control device. The spindle is supported by the frame for rotatable movement within the frame. The gear wheel is disposed around the locking head and has rotatable movement around the locking head. In order for torque to be transferred from the gear wheel to the locking head, a shearing pin is fixedly connected to the gear wheel and the locking head. In the event of a vehicle collision, a pretensioner will rotate the spindle and the locking head such that the shear pin will shear, limiting the effect of the gear wheel on the rotation of the spindle.

### BACKGROUND

1. Technical Field

The present invention relates to a motor vehicle occupant restraint seatbelt system and more specifically to a retractor for retracting a motor vehicle occupant seatbelt having a pretensioning device that pretensions the seatbelt prior to or during a vehicle collision.

2. Description of the Known Technology

Seatbelt retractors are well known in the art. Typically, the retractor includes a torsion spring providing a force to retract the seatbelt. More recently, electric drive retractors have been developed which include an electric motor connected to a gear assembly which retracts the seatbelt. Conventional retractors generally include an emergency locking mechanism which allows retraction of the seatbelt during normal driving conditions, yet locks the retractor when acceleration loads act on the vehicle. Thus, occupant movement is restrained for providing impact protection. Currently, some retractors may also have a pretensioning device to pretension the seatbelt retractor on which the seatbelt webbing is wound by rotating the retractor spool. This cinches or pretensions the webbing to engage the occupant more effectively early in the crash sequence. As well known in the art, once the pretensioner device has partially retracted the seatbelt webbing, a torsion bar will torsionally defleet, allowing protraction of the seatbelt webbing under occupant loading during the vehicle collision, thus providing a webbing tension load limiting feature.

Design challenges arise in the combination of retractor control features such as electric drives and locking system with a petensioner device. For example, in the event of a vehicle collision, the pretensioner device will pretension the seatbelt which should not be impeded by other retractor control systems. Interference posed by such systems could render the pretensioning device less effective.

Therefore, there is a need for a new and improved retractor that will be able to retract the seatbelt, while at the same time, limiting the effects of retractor control systems on the operation of a pretensioning device during a vehicle collision.

### BRIEF SUMMARY OF THE INVENTION

An embodiment of the retractor in accordance with the present invention includes a frame, a spindle, a locking head, a gear wheel and a gear wheel control device. The spindle is supported by the frame for rotatable movement within the frame. The locking head has a locking element that engages the gear wheel to prevent the rotation of the spindle and the retraction of the seatbelt. The gear wheel is disposed around the locking head and undergoes rotatable movement around the locking head. The locking head has at least one locking element for selectively engaging and locking the locking head to the gear wheel. In order for torque to be transferred from the gear wheel to the locking head, a shear pin is fixedly connected to the gear wheel and the locking head. A gear wheel control device will turn the gear wheel. The shear pin intentionally fails as the pretensioner device acts to rapidly retract the seatbelt by driving the spindle. Thus, the relatively slow response characteristics of the electric retractor drive does not impede the action of the pretensioner.

In another aspect of the invention, a torsion bar is disposed within the spindle. The torsion bar has a first portion having a first end connected to the locking head and a second end connected to the spindle. The torsion bar may further include a second portion connected to the second end of the first portion. The second portion may have an end connected to a pretensioner.

In another aspect of the invention, the gear wheel control device is a motor having an output configured to rotate the gear wheel. Preferably, the motor is an electric motor and the output of the motor is a worm gear.

These and other aspects and advantages of the present invention will become apparent upon reading the following detailed description of the invention in combination with the accompanying drawings.

### BRIEF DESCRIPTION OF THE DRAWINGS

FIG. 1 is a cross-sectional perspective view of a seatbelt retractor, embodying the principles of the present invention; and

FIG. 2 is a cross-sectional view of the seatbelt retractor of FIG. 1, embodying the principles of the present invention.

### DETAILED DESCRIPTION OF THE INVENTION

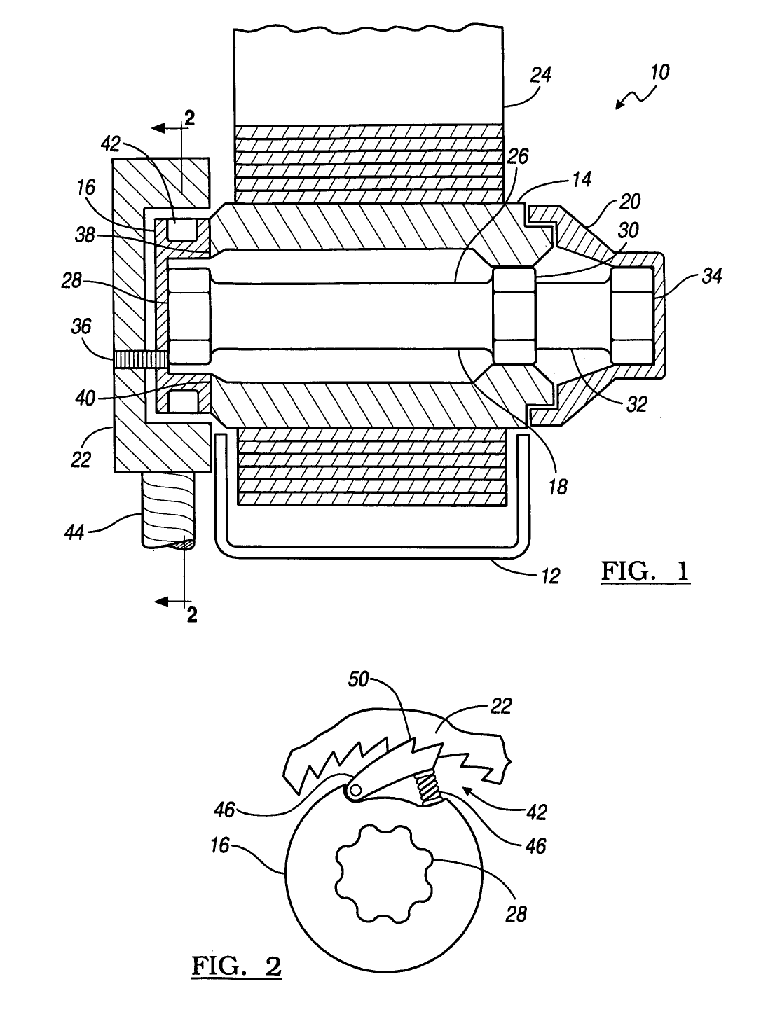

Referring now to FIG. 1, a cross-sectional view of a seatbelt retractor 10 is shown. The seatbelt retractor 10 includes a frame 12, a spindle 14, a locking head 16, a torsion bar 18, a pretensioner end cap 20 and a gear wheel 22. The frame 12 is provided to secure the retractor to the vehicle structure (not shown) and support spindle 14. A seatbelt webbing 24 is wound about spindle 14. As known in the art, as the spindle 14 is rotated in a first direction, the seatbelt 24 is retracted or wound onto spindle 14, and when the spindle is rotated in the second direction, the seatbelt 14 is protracted or unwound from the spindle 14.

The torsion bar 18 is disposed within the spindle 14 and includes a first portion 26 having a first end 28 connected to the locking head, a second end 30 connected to the spindle 14 and a second portion 32 connected to the second end 34.

The second spindle portion 32 has an end 34 fixedly attached to a pretensioner end cap 20. Torsion bar 18 acts as a load-limiting device. Upon loading of the seatbelt webbing during a vehicle impact, the torsion bar 18 twists along either the first portion 26 or the second portion 32, thus allowing the spindle 14 to rotate to pay out or protract a predefined amount of seatbelt webbing from the retractor 10. The twisting of the torsion bar 18 will reduce peak loads on the vehicle occupant.

The pretensioner end cap 20 is disposed proximate to spindle 14 and opposite of the first end 28 of the first portion 26. In operation, the pretensioner end cap 20 is acted on by a pretensioner device (not shown) to rotate spindle 14 through the torsion bar 18. The pretensioner may be similar to the pretensioner (rotary tightening device) shown in U.S. patent application Ser. No. 5,881,962, which is hereby incorporated by reference. As will be more fully explained later, the pretensioner end cap 20 rotates the spindle end 34 which in turn rotates spindle 14. Although it is preferred that the seatbelt retractor 10 include the pretensioner end cap 20 and pretensioner (not shown), the seatbelt retractor 10 may not include the pretensioner end cap 20 and the pretensioner (not shown).

As stated earlier, the locking head 16 is connected to a first end 28 of the first spindle portion 26. The gear wheel 22 is disposed around the locking head 16 and capable of rotating around the locking head 16. A shear pin 36 connects the gear wheel 22 to the locking head 16. When the gear wheel 22 is rotated, the shear pin 36 will transfer torque from the gear wheel 22 to the locking head 16. Therefore the locking head 16 will rotate when the gear wheel 22 rotates so long as shear pin 36 remains intact.

A gear wheel control device includes a motor (not shown) a worm gear 44. The motor (not shown) is preferably an electric motor, connected to the worm gear 44. The worm gear 44 is in meshing engagement with the gear wheel 22. When the worm gear 44 rotates in a first direction, the gear wheel 22 will rotate in a first direction. When the worm gear 44 rotates in a second direction, the gear wheel 22 will rotate in a second direction. In the event of a vehicle collision, the pretensioner (not shown) will rapidly rotate the locking head 16 through the pretensioner end cap 20 and the torsion bar 18. The shear pin 36 will shear and the locking head 16 will no longer be rigidly connected to the gear wheel 22. By eliminating the rigid mechanical connection between the locking head 16 and the gear wheel 22; the locking head 16, the torsion bar 18 and the spindle 14 can rotate freely without restriction from the gear wheel 22, and the relatively slow rotational speed response characteristics of the worm gear 44 and the motor (not shown). Thus, the pretensioner (not shown) can drive the spindle 14 in a direction of retracting the seatbelt despite the fact that the rate of rotation of the gear wheel 22 is limited.

Referring now to FIG. 1 and FIG. 2, locking head 16 and spindle 14 are configured to slidably mate at mating surfaces 38 and 40. Thus, spindle 14 will rotate relative to the locking head 16. A locking element 42 is disposed within the locking head 16 and interacts with gear wheel 22. The locking element 42 includes locking pawl 46 which is pivotally mounted to locking head 16. Further, locking element 42 includes a spring 48 for biasing the locking pawl 46 toward gear wheel 22. The gear wheel 22 further include locking teeth 50 which engage the locking pawl 44.

Configured as described above, the locking element 42 locks, in a protraction direction, the locking head 16 to the gear wheel 22. Conversely, the locking element 42 allows the locking head 16 to rotate in a retraction direction. Thus, the seatbelt 24 can protract when the gear wheel 22 rotates in the protraction direction or during the load limiting function of the torsion bar 18.

In the event of an automobile collision, the pretensioner device (not shown) will rotate the pretensioner end cap 20, such that the seatbelt 24 retracts. When the pretensioner (not shown) rotates the pretensioner end cap 20, the shear pin 36 will shear and the locking head 16 will rotate, thus, retracting the seatbelt 24. After the pretensioner end cap 20 has been rotated by the pretensioner device (not shown), the locking element 42 will prevent the protraction of the seatbelt 24.

While the above description constitutes the preferred embodiment of the present invention, it will be appreciated that the invention is susceptible to modification, variation, and change without departing from the proper scope and fair meaning of the accompanying claims.

We claim:

1. A seatbelt retractor comprising:
a spindle supported by a frame for rotatable movement within the frame;
a locking head selectively engaged to the spindle;
a pretensioner configured to rotate the spindle in a retraction direction in the event of an automobile collision;
a gear wheel;
a connector for connecting the gear wheel to the locking head, whereby the connector will disconnect the gear wheel from the locking head when the pretensioner rotates the spindle in the retraction direction;
a gear wheel control device connected to the gear wheel; and
a locking element connected to the locking head and configured to restrict the rotation of the spindle in a protraction direction.

2. The device of claim 1, wherein the connector is a shear pin located between the gear wheel and the locking head.

3. The device of claim 1, wherein the gear wheel control device is a motor having an output shaft coupled to rotate the gear wheel.

4. The device of claim 3, wherein the motor is an electric motor.

5. The device of claim 3, wherein the output shaft is a worm gear.

6. The device of claim 1, further comprising a torsion bar disposed within the spindle, the torsion bar having a first end connected to the locking head and a second end connected to the spindle.

7. The device of claim 6, wherein the torsion bar is connected to the pretensioner.

8. The device of claim 6, wherein the torsion bar further comprises a second portion connected to the second end.

9. The device of claim 8, wherein the pretensioner is connected to the second portion.

10. A seatbelt retractor comprising:
a spindle supported by a frame for rotatable movement within the frame;
a locking head selectively engaged to the spindle;
a pretensioner configured to rotate the spindle in a retraction direction in the event of an automobile collision;
a gear wheel;
a shear pin for connecting the gear wheel to the locking head, whereby the shearing pin will fail and disconnect the gear wheel from the locking head when the pretensioner rotates the spindle in the retraction direction;
an electric motor having an output shaft coupled to rotate the gear wheel; and
a locking element connected to the locking head and configured to restrict the rotation of the spindle in a protraction direction.

11. The device of claim 10, wherein the output shaft is a worm gear.

12. The device of claim 10, further comprising a torsion bar disposed within the spindle, the torsion bar having a first end connected to the locking head and a second end connected to the spindle.

13. The device of claim 12, wherein the torsion bar is connected to the pretensioner.

14. The device of claim 12, wherein the torsion bar further comprises a second portion connected to the second end.

15. The device of claim 14, wherein the pretensioner is connected to the second portion.
